(19) United States
(12) Patent Application Publication
(10) Pub. No.: US 2002/0120218 A1
(43) Pub. Date: Aug. 29, 2002

(54) Ultrasonic cosmetic treatment device

(75) Inventors: Takafumi Oba, Hikone-shi (JP); Masayuki Hayashi, Hikone-shi (JP)

Correspondence Address: GREENBLUM & BERNSTEIN, P.L.C., 1941 ROLAND CLARKE PLACE, RESTON, VA, 20191, US

(73) Assignee: Matsushita Electric Works, Ltd., Osaka (JP)

(21) Appl. No.: 10/077,809

(22) Filed: Feb. 20, 2002

(30) Foreign Application Priority Data
Feb. 23, 2001 (JP) 2001-049205

(51) Int. Cl. A61H 23/00

(52) U.S. Cl. 601/2

(57) ABSTRACT

An ultrasonic cosmetic treatment device that uses a simple electrical circuit structure to provide an effective method of controlling a thermal emission from a vibrating part when the vibrating part is not in contact with a predetermined surface, such as, for example, the skin of a person. The invention uses a probe comprised of a contact part on whose rear surface is attached an ultrasonic oscillator, and an oscillation circuit that drives the ultrasonic oscillator. An electrical load is applied to the vibrating part when the vibrating part is brought into contact with the skin, and released when the vibrating part is separated from the skin. The ultrasonic oscillator is controlled through a changeable oscillating frequency that is based on a larger impedance value for the vibrating part's non-load applied condition as compared to a smaller impedance value for a load applied condition.

### BACKGROUND OF THE INVENTION

1. Field of the Invention

The invention relates to an ultrasonic cosmetic treatment device of the type that includes a vibrating part incorporating an ultrasonic oscillator. The vibrating part is placed in contact with, for example, a face or an other part of a body, so as to serve as a device for applying ultrasonic waves to the skin.

2. Background of the Related Art

In the past few years, various ultrasonic cosmetic treatment devices have been developed that include a vibrating part that is pressed against, for example, the skin of the face. This vibrating part is installed in a tip of a probe and includes a metallic member to which an ultrasonic oscillator is attached as a mechanism for applying ultrasonic waves to the skin. These devices have a propensity to raise the operating temperature of the device as a result of thermal emissions generated when the vibrating part at the tip of the probe is removed from the skin, which results in the free, unfettered operation of the ultrasonic oscillator.

Specifically, the ultrasonic energy transferred to the metallic member causes the vibrating part to increase in temperature as a result of the acoustic impedance between the air and metallic member being larger than that between the skin and metallic member. This phenomenon results in more of the ultrasonic waves being reflected back into the metallic member when the probe is separated (removed) from the skin, due to the inability of the waves to efficiently radiate into the surrounding air atmosphere. As a result, the user of the ultrasonic cosmetic device experiences a discomfort when the vibrating part, having an elevated temperature, is brought back into contact with the skin.

To overcome this shortcoming, Japanese Laid Open Patent Publication HEI 11-114000 describes an ultrasonic cosmetic treatment device that incorporates a monitoring circuit that is capable of detecting whether the vibrating part of the probe is (or is not) in contact with the skin, thus providing a control function through which an oscillation control circuit that drives the ultrasonic oscillator is able to adjust the output of the oscillation circuit that drives the ultrasonic oscillator, based on the operation of the monitoring circuit.

This type of ultrasonic cosmetic treatment device responds to whether or not the vibrating part, in the tip of the probe, is separated from the skin by reducing the amount of heat generated at the vibrating part by decreasing the output of the oscillating circuit when the vibrating part in the tip of the probe is separated from the skin, and by increasing the output of the oscillating circuit when the vibrating part at the tip of the probe comes into contact with the skin.

The ultrasonic cosmetic treatment device described by the aforesaid laid open Japanese patent publication, however, exhibits certain shortcomings in that, in addition to the need to incorporate an oscillation circuit to drive the ultrasonic oscillator, it further requires a monitoring circuit to determine whether the vibrating part at the tip of the probe is in contact with the skin, and an oscillation control circuit to adjust the output level of the oscillation circuit in response to the monitoring circuit. Thus, it is difficult to manufacture the ultrasonic cosmetic treatment device inexpensively and to design the same to be compact.

### SUMMARY OF THE INVENTION

The invention that is the subject matter of the present application takes the aforesaid shortcomings into consideration to propose an ultrasonic cosmetic treatment device that incorporates a simple electronic circuit capable of effectively controlling thermal emission from the vibrating part when the probe is not in contact with the skin.

According to the first embodiment of the invention, an ultrasonic cosmetic treatment device is provided that is capable of applying ultrasonic waves to the skin. The device incorporates a probe that includes a vibrating part comprising an ultrasonic oscillator positioned to the rear surface of a skin contact member. A load applied condition occurs when the vibrating part is placed in contact with the skin, and a non-load applied condition occurs when the vibrating part is separated from the skin, thus causing the impedance value of the vibrating part to increase during a non-load applied condition as compared to a load applied condition. The invention also includes an oscillation circuit that drives the ultrasonic oscillator at a frequency such that the impedance value of the non-load applied vibrating part is larger than that in the load applied condition.

A decrease in rated power supplied by the oscillation circuit to the probe's vibrating part occurs when the vibrating part is in a load applied condition resulting from the skin contact. Because this supply power is reduced to a level below the rated power for the larger impedance value of the vibrating part in a non-load applied condition when not in contact with the skin, a mechanism is provided whereby a heat emission from the vibrating part can be controlled. As a result, this type of circuit structure is able to eliminate the previously described monitoring circuit used to detect a skin contact (or non-contact) condition, and also to eliminate the oscillation control circuit used to control the output of the oscillation circuit, thus allowing for a simple and more compact circuit structure that can reduce manufacturing costs.

A second embodiment of the invention is similar to that of the first embodiment, but with the oscillation circuit being structured as a separate exciter oscillation circuit having a constant frequency oscillation output that relates to the increased impedance value of the vibrating part when the probe is in a non-load applied condition as compared to a load applied condition.

As this structure provides a mechanism by which a constant frequency output from the oscillation circuit is supplied to the ultrasonic oscillator, the supplied power for the larger impedance value of a non-load applied condition, as compared to its load applied condition, is markedly less than the rated power. As a result of this mechanism, heat emissions from the vibrating part of the probe can be effectively controlled.

According to a third embodiment, an invention similar to that of the first embodiment with the oscillation circuit being structured as a separate exciter type oscillation circuit is provided. However, this embodiment includes a voltage control device that is able to adjust the voltage supplied by the oscillation circuit to the ultrasonic vibrating part. A frequency alteration system is provided to change the oscillation frequency of the oscillation circuit, in response to the aforesaid voltage, to a level that relates to the larger impedance value of the vibrating part during a non-load applied condition as compared to the smaller impedance of a load applied condition. This structure makes it possible to switch the acoustic output level of the ultrasonic oscillator by changing the voltage level supplied thereto, and to reduce the amount of supplied power during the increased impedance non-load applied condition, regardless of the changes in acoustic output level, to a level less than the rated power. This results in effective control of heat emission from the vibrating part of the probe.

According to a fourth embodiment, an invention similar to that of the first embodiment is provided. However, the oscillation circuit is structured as a self exciter type oscillation circuit. This fourth embodiment also includes an oscillation frequency rectification circuit capable of adjusting the oscillation frequency of the oscillation circuit in response to a larger impedance value of the vibrating part in a non-load applied condition as compared to a smaller impedance value of a load applied condition.

This structure makes it possible for the oscillation frequency rectification circuit to shift the oscillation frequency of the self exciter oscillation circuit into a range for the vibrating part's larger impedance value during a non-load applied condition as compared to the smaller impedance value of a load applied condition. As a result, this type of circuit structure eliminates the need for a conventional monitoring circuit used to detect a skin contact or non-contact condition, and also eliminates the oscillation control circuit used to control the output level of the oscillation circuit, thus allowing for a simple and more compact circuit structure that can be manufactured more economically.

According to another embodiment of the present invention, an ultrasonic treatment device has an ultrasonic oscillator, a contact member, and an oscillation circuit. The oscillator circuit drives the ultrasonic oscillator to vibrate at a predetermined frequency. The oscillation circuit drives the ultrasonic oscillator at a first predetermined frequency when the contact member is in proximate contact with a predetermined surface. Further, the oscillation circuit drives the ultrasonic oscillator at a second predetermined frequency when the contact member is not in proximate contact with the predetermined surface.

According to an advantage of the invention, the first predetermined frequency corresponds to a frequency having a first impedance value. The second predetermined frequency corresponds to a frequency having a second impedance value. Furthermore, the predetermined surface is an outer covering of a body, such as, but not limited to, for example, a skin of a body, such as a face of an individual.

According to a feature of the invention, the oscillation circuit may be an exciter type oscillation circuit.

A still further feature of the invention is that the treatment device may additionally include an output voltage converting device, and/or an oscillation frequency rectifier device that is interposed between the oscillation circuit and the ultrasonic oscillator.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a block diagram illustrating a general structure of the present invention;

FIG. 2 is cross sectional view of a probe part of the present invention;

FIG. 3 is a graph illustrating an oscillation frequency vs. impedance characteristics of the present invention;

FIG. 4 is a block diagram of a second embodiment of the present invention;

FIG. 5 is a block diagram of a third embodiment of the present invention;

FIG. 6 is a graph illustrating an oscillation frequency vs. impedance characteristics of the probe part of the present invention;

FIG. 7 is a timing chart illustrating the operation of the present invention;

FIG. 8 is a block diagram of a fourth embodiment of the present invention;

FIGS. 9A and 9B are graphs showing frequency vs. impedance and frequency vs. phase characteristics of the probe part of the present invention when the oscillation circuit is structured as a self exciting type oscillation circuit; and

FIGS. 10A and 10B are graphs showing frequency vs. impedance and frequency vs. phase characteristics of the probe part of the invention of FIG. 8.

### DETAILED DESCRIPTION OF THE INVENTION

The particulars shown herein are by way of non-limiting examples and are for purposes of illustrative discussion of the embodiments of the present invention only, and are presented to provide what is believed to be a useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

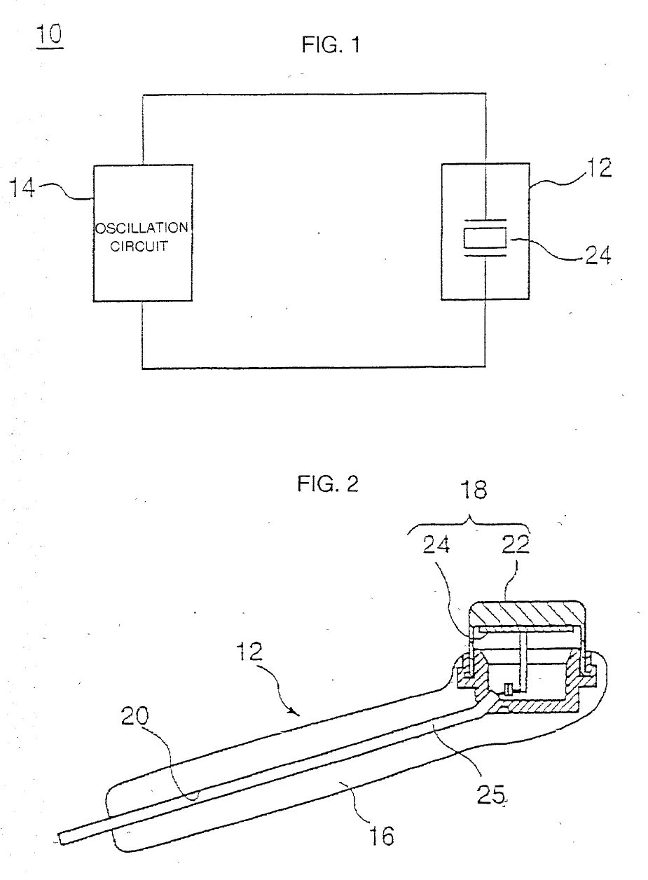

FIG. 1 is a block diagram illustrating a first embodiment of the ultrasonic cosmetic treatment device of the present invention. Ultrasonic cosmetic treatment device 10 includes probe 12 that is held against an outer covering of a body, such as, but not limited to, for example, the skin on the face (or an other part of a body) to apply ultrasonic vibrations to the skin, and oscillation circuit 14 that supplies electrical power to probe 12.

As described in FIG. 2, probe 12 is equipped with a grip part 16 that is grasped by the hand when the probe is used, and vibrating part 18, located at the end of the grip part 16, that comes into contact with the skin on the face. Grip part 16 is made from, for example, a synthetic resin and incorporates a channel 20 formed as an axially extending opening into which an electrical cord 25 is installed. Moreover, vibrating part 18 incorporates skin contact member 22, made from, for example, a metallic material, attached to its forward facing surface, and an ultrasonic piezoelectric oscillator 24 having a piezoelectric element, attached to its rearward facing surface. Cord 25 is attached to the terminals of the ultrasonic oscillator 24, runs through channel 20 of grip part 16, and extends out of grip part 16 to connect to an externally located oscillation circuit 14. However, it is understood that the construction of the probe 12 may be varied without departing from the spirit and/in scope of the invention. Similarly, the oscillation circuit may be housed in the probe 12 without departing from the scope and/or spirit of the invention.

Oscillation circuit 14, having either a self exciter or separate exciter type oscillation circuit, drives ultrasonic oscillator 24, which is attached to the skin contact member 22, by supplying an oscillation output voltage at a specific oscillation frequency in an anti-resonance region (e.g., high impedance value) of ultrasonic oscillator 24. When ultrasonic oscillator 24 is driven in this manner, the ultrasonic vibrations from vibrating part 18 are transferred to the skin when vibrating part 18 is in contact with the skin. In addition, oscillation circuit 14 may be housed within an externally located drive unit.

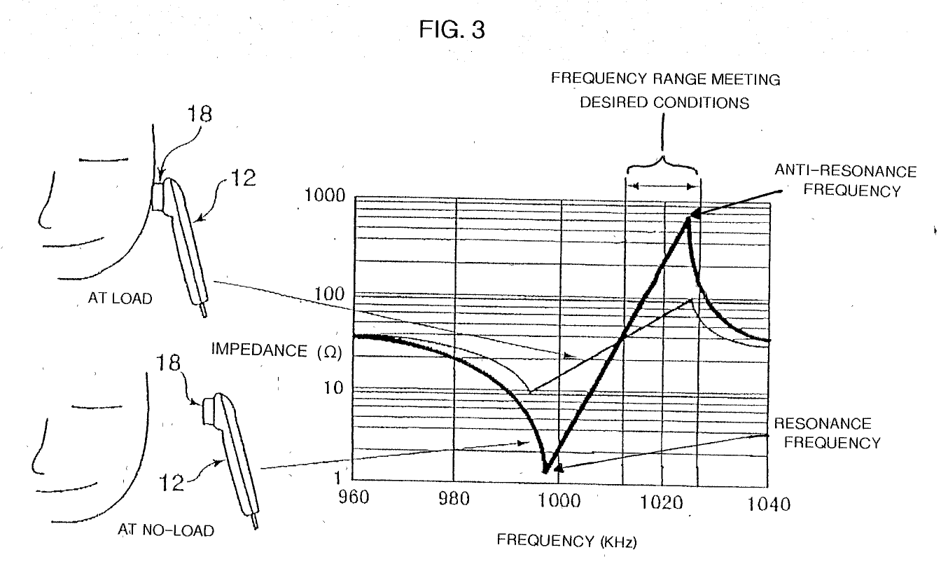

As shown in FIG. 3, vibrating part 18 has an impedance vs. frequency characteristic which, in regard to a specific frequency range, demonstrates a resonance for the lowest impedance value (e.g., the impedance of ultrasonic oscillator attached to skin contact member 22) and an anti-resonance for the highest impedance value.

This frequency vs. impedance characteristic exhibits differences that correspond to vibrating part 18 being in a load applied or non-load applied condition. A load applied condition results from part 18 being in contact with the skin, and a non-load applied condition results from part 18 not being in contact with the skin. In other words, vibrating part 18, as described in this embodiment, exhibits a small impedance value in the frequency range of the resonant region below approximately 1,012 KHz when in a non-load applied condition, and a large impedance value in the frequency range of the anti-resonance region above approximately 1,012 KHz when in a load applied condition. However, it is understood that alternative vibrating parts may be utilized that exhibit a resonant region and an anti-resource region at a frequency other than 1,012 KHz, without depending from the spirit and/or scope of the invention.

As a result, when vibrating part 18 is in contact with the skin (vibrating part 18 then being in a load applied condition) with ultrasonic oscillator 24 driven at a frequency in the anti-resonance region, ultrasonic vibrations are applied to the skin at a specific acoustic level for the rated power being supplied to ultrasonic oscillator 24. When vibrating part 18 is not in contact with the skin (vibrating part 18 then being in a non-load applied condition), the power supplied to ultrasonic oscillator 24 decreases to a level below the rated power as a result of the impedance value of vibrating part 18 increasing as compared to a decrease in impedance for a load applied condition. This mechanism is thus able to provide means through which heat emissions from vibrating part 18 can be effectively controlled.

To explain further, if we label the impedance value from loaded vibrating part 18 as “Z1,” the unloaded impedance value as “Z0,” the drive voltage supplied to ultrasonic oscillator 24 as “V,” and the power supplied to ultrasonic oscillator 24 during a load applied condition and a non-loaded applied condition as “W1” and “W0”, respectively, the power supplied to ultrasonic oscillator 24 can be calculated from the following two formulas:

W1=V²/Z1;

W0=V²/Z0.

Because Z1 is smaller than Z0, W1 is larger than W0, and it becomes possible to control heat emissions from vibrating part 18.

Applying this type of mechanism to the first embodiment, the output voltage for the oscillating frequency can be supplied to ultrasonic oscillator 24 within the anti-resonance frequency region (shown in FIG. 3) for vibrating part 18 (ultrasonic oscillator 24 being attached to the skin contact member 22), thus eliminating the need for a monitoring circuit to detect whether the vibrating part 18 is in (or out of) contact with the skin, and further eliminating the need for an oscillation control circuit to control the output level of the oscillation circuit in response to the monitored results. Moreover, energy demands can be reduced due to the decrease in power consumption during the non-load applied condition.

In regard to the impedance vs. frequency characteristics shown in FIG. 3, the frequency range labeled “Frequency Range Meeting Desired Conditions” is the range in which heat emission from the non-load applied vibrating part 18 can be controlled without a decrease in the efficiency of the oscillation circuit. It is also possible to set the oscillation circuit oscillation frequency beyond the upper limit of the oscillation frequency range.

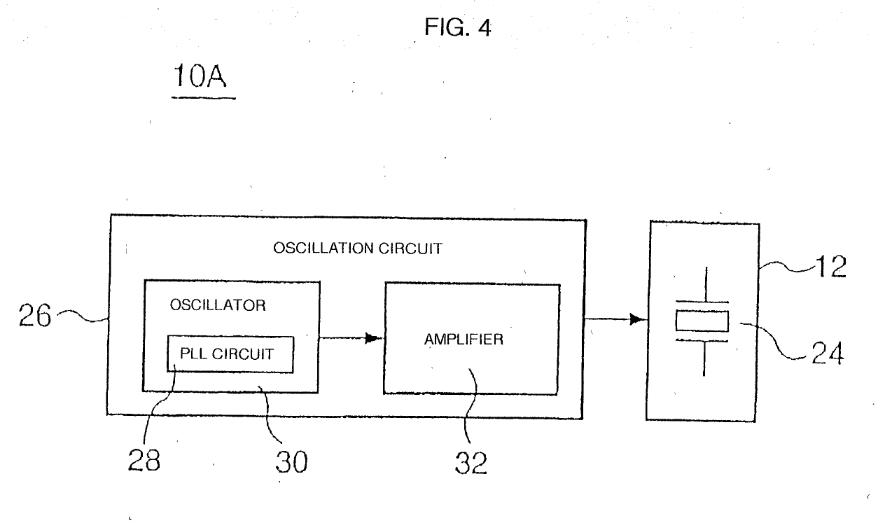

FIG. 4 is a block diagram describing a second embodiment of the ultrasonic cosmetic treatment device invention. In the second embodiment, oscillation circuit 26 of ultrasonic cosmetic treatment device 10A is structured as a separate exciter oscillation circuit. As the structure of probe 12 has been previously described in the first embodiment and is essentially the same for this second embodiment, illustrations and explanations of the components comprising probe 12 will be omitted, but the same element numbers will be applied in the description of this second embodiment. The following description will deal with only those parts of the second embodiment of the invention that substantially differ from the first embodiment.

The second embodiment ultrasonic cosmetic treatment device 10A includes probe 12, to which ultrasonic oscillator 24 is installed (as explained in the first embodiment) and separate exciter oscillation circuit 26 that drives ultrasonic oscillator 24. Separate exciter oscillation circuit 26 includes an oscillator 30 whose oscillating frequency is controlled by the phase locked loop (PLL) circuit 28, and an amplifier (amplifier circuit) 32 which is used to amplify the oscillating output of oscillator 30.

Phase locked loop circuit 28 includes components that make use of publicly known technology, such as, but not limited to, for example, a programmable frequency divider, a phase comparator, voltage controlled oscillator, and low range filter. The circuit can be structured, for example, so that the oscillation frequency is adjusted by applying the output voltage from a programmable frequency divider (not shown) to a variable capacity diode (not shown) associated with oscillator 30. In this embodiment, however, a circuit is employed wherein oscillator 30 oscillates at a predetermined constant frequency (the frequency encompassing the anti-resonance range shown in FIG. 3) resulting from a constant voltage applied to the variable capacity diode. The oscillation output is then amplified by amplifier 32 and supplied to the ultrasonic oscillator 24, thus providing for a more stabilized method of driving the ultrasonic oscillator 24.

In the second embodiment of the invention, oscillation circuit 26 is a separate exciter oscillation circuit structured so as to oscillate at a constant frequency in relation to the larger impedance value of vibrating part 18 resulting from part 18 being in a non-load applied condition, as compared to the small impedance value when the parts 18 is in the loaded condition. This second embodiment thus offers the same operational effect as the first embodiment, and because of the stable oscillation frequency provided by oscillation circuit 26, a stable ultrasonic vibration can be applied to the skin when vibrating part 18 is in the load applied condition. As a result, the thermal emission from the vibrating part 18 can be effectively controlled when the vibrating part 18 is in the non-load applied condition (e.g., vibrating part 18 is separated from the skin).

Furthermore, while this second embodiment provides for a highly stable oscillating frequency emanating from oscillation circuit 26 as a result of the inclusion of the phase locked loop circuit 28, stabilizing circuits of other design may also be applied to provide the stabilizing effect.

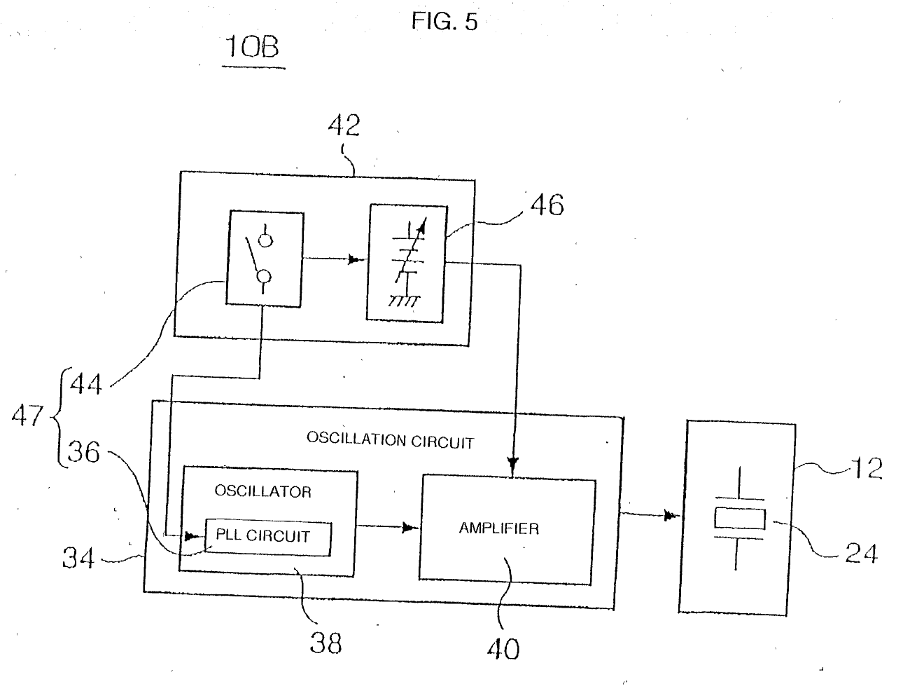

FIG. 5 is a block diagram describing a third embodiment of the ultrasonic cosmetic treatment device invention, in which an oscillation circuit 34 of ultrasonic cosmetic treatment device 10B is structured as a separate exciter oscillation circuit as described in the second embodiment. As the structure of probe 12 has been previously described in the first embodiment and is essentially the same for this third embodiment, illustrations and explanations of the components comprising probe 12 will be omitted but the same component numbers will be applied in the descriptions of this third embodiment. The following descriptions will deal with only those parts of the third embodiment that substantially differ from the first embodiment.

In the third embodiment, ultrasonic cosmetic treatment device 10B includes probe 12 which is equipped with ultrasonic oscillator 24 as previously described in the first embodiment, and separate exciter oscillation circuit 34 which is used to drive ultrasonic oscillator 24. Separate exciter oscillating circuit 34 includes an oscillation circuit 38 whose oscillating frequency is controlled by an oscillating frequency generated by phase locked loop circuit 36, and amplifier (amplification circuit) 40 that amplifies the oscillating output of oscillator 38. Moreover, ultrasonic cosmetic treatment device 10B, as described in this third embodiment, incorporates an output voltage conversion circuit 42 that operates as an output voltage conversion part capable of switching the acoustic output, which is the mechanical vibrating output generated by ultrasonic oscillator 24, between a high state and a low level state.

Phase lock loop circuit 36 is structured identically to that described in the second embodiment and can operate, for example, in a manner in which the voltage output from the programmable frequency divider is applied to the variable capacity diode installed in oscillating part 38 to change the oscillating frequency of oscillator 38.

Output voltage conversion circuit 42 is structured so that the drive voltage supplied to amplifier 40 from a drive power source 46 can be changed to a HIGH or LOW level as a result of the switching operation of a changeover switch 44. That is, the drive power source 46 functions to switch the output voltage (e.g., the drive voltage applied to amplifier 40) between a HIGH and LOW level based on the input from the changeover switch 44. The drive power source 46 is configured as a constant DC voltage source that can change its output voltage. The output amplitude of amplifier 40 increases when supplied with a high level drive voltage, and decreases when supplied with a low level drive voltage. Due to this mechanism, the acoustical output of ultrasonic oscillator 24 increases as a result of the increase in supplied power when there is a large amplitude output from amplifier 40, and decreases as a result of the decrease in supplied power when there is a small amplitude output from amplifier 40.

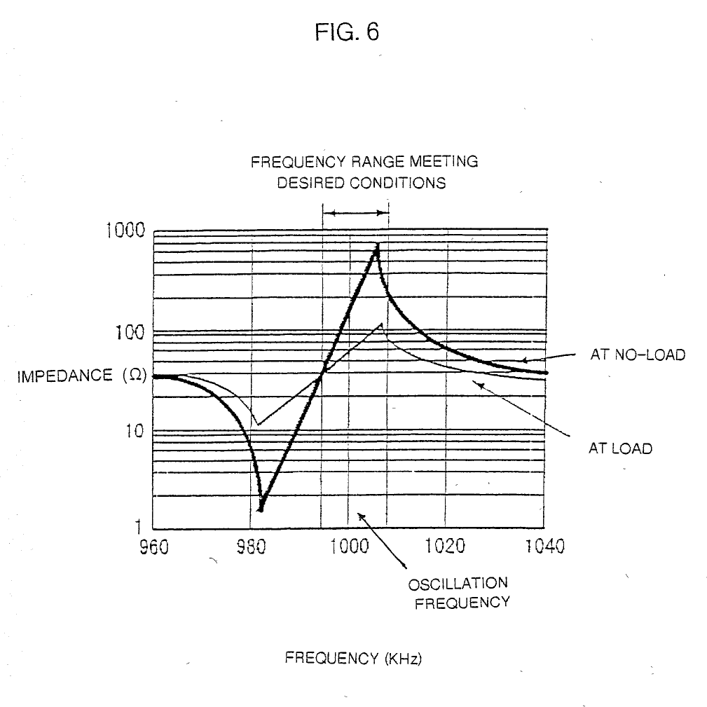

Moreover, in regard to the frequency vs. impedance characteristics of vibrating part 18, while FIG. 3 shows the high drive voltage condition, FIG. 6 shows a state in which the resonance and anti-resonance ranges have shifted to a lower frequency than that shown in FIG. 3. During a low level drive voltage condition, the change in output voltage from the programmable frequency divider located in the phase locked loop circuit 36, for example, can induce a change in the setting of the variable capacity diode in oscillator 38, thus causing a shift of the oscillation frequency to the anti-resonance region as a result of the decreased drive voltage.

In other words, a changeover signal from the operation of the changeover switch 44 is supplied to the phase locked loop circuit 36, thus causing a corresponding change in the voltage output of, for example, a programmable frequency divider. In addition, the changeover switch 44 and phase locked loop circuit 36 are incorporated into the frequency conversion circuit 47 to change the oscillating frequency of the oscillation circuit 34.

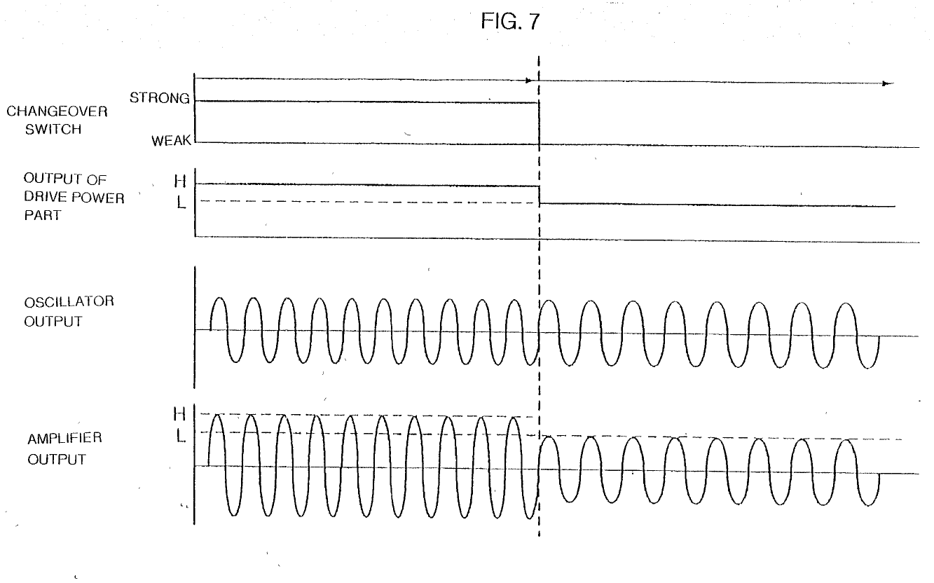

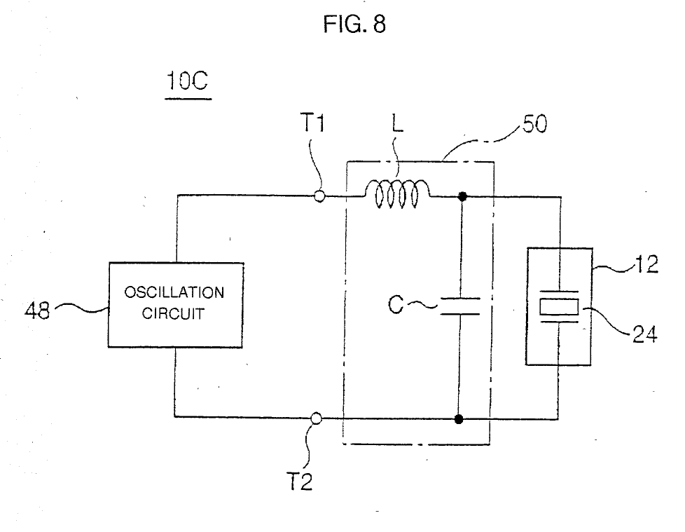

FIG. 7 shows the operating waveforms for each component of the ultrasonic cosmetic treatment device 10B as described in the third embodiment. When the changeover switch 44 assumes a high level state (shown as “strong” in FIG. 8), for example, when a HIGH signal is output from the changeover switch 44, an increased drive voltage is output from the drive power source 46 and supplied to amplifier 40. At this time, oscillator 38 operates at a frequency within the anti-resonance region shown in FIG. 3 (a frequency higher than that of the anti-resonance frequency point region shown in FIG. 6). Amplifier 40 then sets the output voltage for that frequency and supplies it to the ultrasonic oscillator 24, thus forming a mechanism through which a larger amplitude ultrasonic vibration is generated when vibrating part 18 is held in contact with the skin.

Conversely, when the changeover switch 44 assumes a low level state (shown as “weak” in FIG. 8), for example, when a LOW signal is output from changeover switch 44, a decreased drive voltage is supplied to amplifier 40 from the drive power source 46. At this time, oscillating part 38 operates at a frequency within the anti-resonance region shown in FIG. 6 (a frequency lower than that of the anti-resonance frequency point region shown in FIG. 6). Amplifier 40, set to a lower level of amplitude, then amplifies the output voltage and supplies it to ultrasonic oscillator 24, thus forming a mechanism through which an ultrasonic vibration of a lesser amplitude is generated when vibrating part 18 is not in contact with the skin.

The third embodiment of the invention incorporates the oscillation circuit 34 structured as a separate exciter oscillation circuit, the output voltage conversion circuit 42 that converts the voltage level output from oscillation circuit 34 supplied to ultrasonic oscillator 24, and the frequency conversion circuit 47 that converts the oscillation frequency of the oscillation circuit 34 based on the voltage level of the frequency, for the large impedance value of oscillating part 18 when in a non-load applied condition as compared to a small impedance value for a load applied condition. These structures and mechanisms enable the third embodiment of the invention to provide the same operational effects as the first embodiment, and makes it possible to change the level of the ultrasonic vibration when the device is put in contact with the skin, thus allowing the user to operate the ultrasonic cosmetic treatment device with a greater degree of comfort.

While the third embodiment employs the frequency conversion circuit 47 structured to include the phase locked loop circuit 38 and the changeover switch 44 as one example of a means for changing the oscillation frequency of oscillation circuit 34, other types of circuit structures may be employed to change the oscillation frequency of oscillation circuit 34 without departing from the scope and/or spirit of the present invention. Moreover, in regard to the frequency vs. impedance characteristics shown in FIG. 6, the frequency region labeled “Frequency Range Meeting Desired Conditions,” as similarly shown in FIG. 3, is the frequency range in which a heat emission can be controlled without any fall-off in the operating efficiency of the oscillation circuit when vibrating part 18 is in a non-load applied condition. This structure also makes it possible to set the oscillation frequency of the oscillating circuit to a level exceeding the upper limit of the frequency range.

FIG. 8 is a block diagram describing a fourth embodiment of the ultrasonic cosmetic device invention. The fourth embodiment, shown as ultrasonic cosmetic treatment device 10C, employs an oscillation circuit structured as a self exciter type of oscillation circuit. As the structure of probe 12 has been previously described in the first embodiment and is essentially the same for this fourth embodiment, detailed illustrations and explanations of probe 12 components will be omitted but the same component numbers will be applied. The following descriptions will deal with only those parts of the fourth embodiment that substantially differ from the first embodiment.

The fourth embodiment of the invention, shown in FIG. 8 as ultrasonic cosmetic treatment device 10C, comprises probe 12 that incorporates the ultrasonic oscillator 24, as described in the first embodiment, a self exciter oscillation circuit 48 that drives the ultrasonic oscillator 24, and oscillation frequency rectifier circuit 50 that incorporates an LC circuit connected to the ultrasonic oscillator 24 and the self exciter oscillation circuit 48.

In this embodiment, the self exciter oscillation circuit 48 is structured as a Colpitts oscillating circuit to which a load (i.e., a synthetic impedance for vibrating part 18 and oscillation frequency rectifier circuit 50) is applied between output terminals T1 and T2, in which the circuit oscillates when the phase angle of the load becomes zero degrees. In other words, oscillation circuit 48 will oscillate at a frequency only when the impedance of the load applied between output terminals T1 and T2 becomes a resistive component (that is, when the imaginary number part of an impedance for a complex number becomes zero). However, it is understood that other types of oscillators may be used without departing from the scope and/or spirit of the instant invention.

Oscillation frequency rectifier circuit 50 may, for example, be located within probe 12, and include an inductor L connected in series to the ultrasonic oscillator 24, and a capacitor C connected in parallel to the ultrasonic oscillator 24, thus providing a mechanism through which a frequency for a zero degree phase load can be shifted into an anti-resonance frequency region output by the ultrasonic oscillator 24.

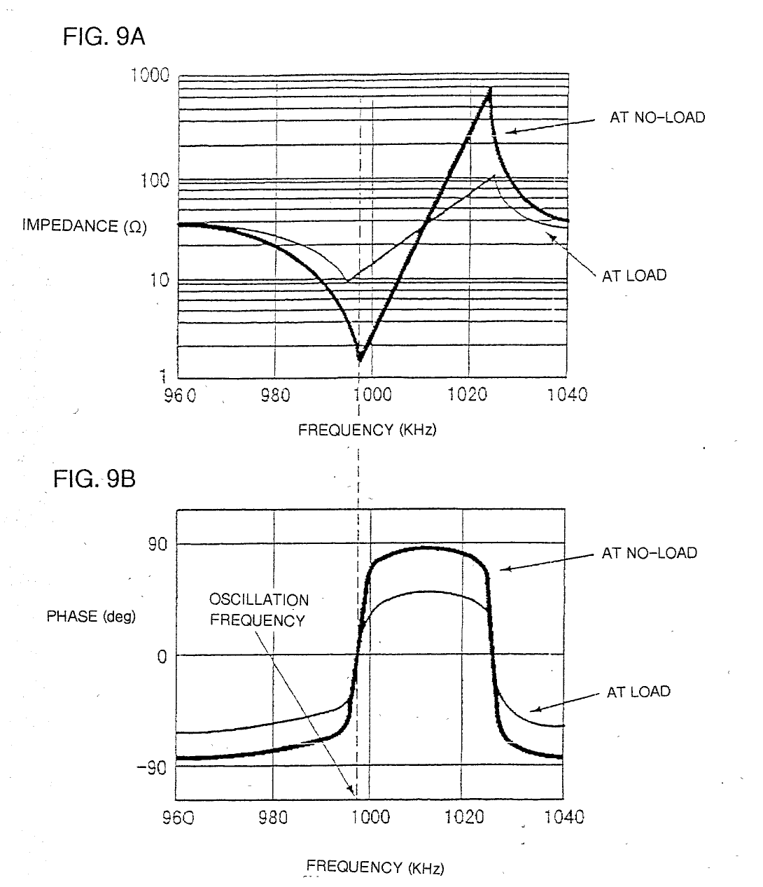

To explain further, the circuit operation will be described for a case in which the ultrasonic cosmetic treatment device 10C is not equipped with the oscillation frequency rectifier circuit 50. As shown by the load frequency vs. phase characteristics in FIG. 9B (relating to the impedance of the vibrating part 18 only), the frequency for a zero degree phase load is the same for both the load applied condition and the non-load applied condition. As a result, the frequency resides within both the frequency resonance and anti-resonance regions in regard to the frequency vs. impedance characteristics of vibrating part 18 (see FIG. 9A).

Due to these characteristics, the frequency output by oscillation circuit 48 moves to the low side when the load phase is a positive (+) value, and as a result of the frequency moving to the high side when the load phase is a negative (−) value, an oscillation frequency is output in relation to the resonance point of the vibrating part 18. When the oscillation circuit 48 operates at this frequency, the power supplied to the ultrasonic oscillator 24 is greater than the rated power, because the impedance value becomes smaller for a non-load applied condition of the vibrating part 18 as compared to a load applied condition, thus causing the temperature of the vibrating part 18 to rise as a result of an increased heat emission.

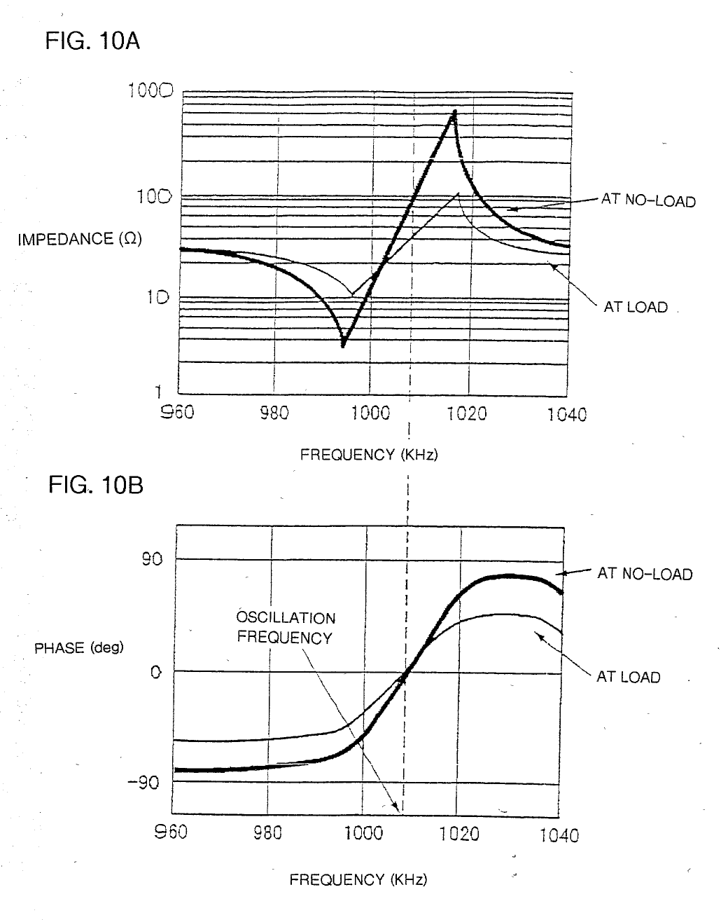

Conversely, as shown in FIGS. 10A and 10B, in the case where the oscillation frequency rectifier circuit 50 is utilized, setting specific values for the inductance L and the capacitance C will result in ultrasonic oscillator 24 shifting the frequency range for a zero degree phase load (a synthetic impedance of vibrating part 18 and oscillation frequency rectifier circuit 50) to a region that includes the anti-resonance for both a load applied condition and a non-load applied condition. As a result, oscillation circuit 48 operates in the anti-resonance region for vibrating part 18. Operating at this frequency, oscillation circuit 48, as a result of the non-load impedance value of vibrating part 18 being larger in comparison to the impedance value for a loaded condition, drives ultrasonic oscillator 24 at a power level less than the rated power, thus effectively controlling a thermal emission from the vibrating part 18.

The invention, described in the fourth embodiment as including a Colpitts type self exciter oscillation circuit, is able to provide the same operational effect of the first embodiment invention, due to the ability of the oscillation frequency rectifier circuit 50 to adjust the oscillation circuit frequency in relation to a large impedance value of the vibrating part 18 as compared to a small impedance value. In addition, this embodiment provides the benefit of a simpler oscillation circuit structure as compared to a separate exciter type oscillation circuit.

While the oscillation frequency rectifier circuit 50 is structured to include the ultrasonic oscillator 24 to which the inductor L is connected in series, and the capacitor C is connected in parallel, this embodiment is not limited to this type of circuit structure alone. Moreover, while this embodiment discloses that the oscillation frequency rectifier circuit 50 is connected between the ultrasonic oscillator 24 and the oscillation circuit 48, the invention is not limited to this type of connection alone.

For example, the oscillation frequency rectifier circuit 50 may be located within the oscillation circuit 48 (in other words, not directly connected to terminals T1 and T2, but a part of circuit 48). In this case, rectifier circuit 50 can be installed within the driver part of the invention which also houses the oscillation circuit 48 to which the probe cord 25 is connected. Furthermore, a structure in which the oscillation frequency rectifier circuit 50 is located between the oscillation circuit 48 and ultrasonic oscillator 24 may be utilized. In this case, the oscillation frequency rectifier circuit 50 may be located within, for example, the probe 12, or connected to the central part of the cord 25 between probe 12 and the driving part.

Moreover, the structure of the self exciter oscillation circuit 48 is not limited to the Colpitts type, but may be structured as, for example, a Hartley or other type of oscillating circuit.

As previously explained, the first embodiment describes an invention incorporating a probe comprised of a skin contact member, a vibrating part, and an ultrasonic oscillator attached to the rear of the vibrating part, a load applied condition being applied to the vibrating part when the vibrating part is in contact with the skin. The first embodiment further comprises an oscillation circuit that, at the time a non-load applied condition exists (as a result of the vibrating part not being in contact with the skin), drives an ultrasonic oscillator at an oscillating frequency relating to the larger impedance value of the non-load applied condition as compared to the smaller impedance value of a loaded condition, thus providing for a simple circuit structure able to effectively control a thermal emission from the vibrating part when not in contact with the skin.

Furthermore, the invention described by the second embodiment incorporates an oscillation circuit structured as a separated exciter type oscillation circuit that oscillates at a constant frequency in relation to the larger impedance value of the vibrating part's non-load applied condition (as opposed to the smaller impedance value of a load applied condition), thus providing a mechanism through which stable ultrasonic oscillation is attained during a load applied condition when the vibrating part is in contact with the skin, and through which the supply power relating to the vibrating part's larger impedance value during a non-load applied condition (as opposed to a small impedance value for a load applied condition) is supplied at a level lower than the rated power, thus providing a method for effectively controlling a heat emission from the vibrating part.

Moreover, the invention described by the third embodiment incorporates an oscillation circuit structured as a separated exciter type oscillation circuit, a voltage changing device that operates to change the voltage level applied to the ultrasonic oscillator from the oscillation circuit, and frequency changing device that operates to change the oscillation frequency of the oscillation circuit according to a voltage that relates to the vibrating part's larger impedance value during a non-load applied condition (as opposed to a smaller impedance for a load applied condition), thus providing a mechanism through which the acoustic output level of the ultrasonic oscillator can be changed, and through which a heat emission from the vibrating part can, regardless of the acoustic output level, be effectively controlled during a non-loaded condition.

In addition, the invention described by the fourth embodiment incorporates an oscillation circuit structured as a self exciter oscillation circuit, and includes an oscillation frequency rectifier circuit that rectifies the frequency output by the oscillation circuit in relation to the vibrating part's larger impedance value for a non-load applied condition (as compared to a smaller impedance value for a load applied condition), thus providing for a simple circuit that effectively reduces thermal emission from the vibrating part when the vibrating part is not in contact with the skin.

It is noted that the foregoing examples have been provided merely for the purpose of explanation and are in no way to be construed as limiting the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and/or spirit of the present invention in its aspects. Although the present invention has been described herein with reference to particular means, materials, and embodiments, the present invention is not intended to be limited to the particulars disclosed herein; rather, the present invention extends to all functionally equivalent structures, methods and uses, such as are within the scope of the appended claims.

The present application claims priority under 35 U.S.C. '§ 119 of Japanese Patent Application No. 2001-049205, filed on Feb. 23, 2001, the disclosure of which is expressly incorporated by reference herein in its entirety.

We claim:

1. An ultrasonic cosmetic treatment device, comprising:
a probe having a vibrating part formed by a contact member and an ultrasonic oscillator attached to a rear side of said contact member; and
an oscillation circuit that drives said ultrasonic oscillator at a frequency corresponding to a first impedance value of said vibrating part when in a non-load applied condition resulting from said vibrating part not being in contact with an outer covering of a body, said first impedance value being larger than a second impedance value of said vibrating part in a load applied condition resulting from said vibrating part being in contact with said outer covering of said body.

2. The ultrasonic cosmetic treatment device of claim 1, wherein said oscillation circuit comprises a separated exciter type oscillation circuit that oscillates at a constant frequency corresponding to said first impedance value of said vibrating part when in said non-load applied condition.

3. The ultrasonic cosmetic treatment device of claim 1, wherein said oscillation circuit comprises a separated exciter type oscillation circuit, said ultrasonic cosmetic treatment device further comprising a voltage changing circuit to change a voltage level applied to said ultrasonic oscillator from said oscillation circuit, and a frequency changing circuit to change an oscillation frequency of said oscillation circuit according to said voltage level in relation to an impedance value of said vibrating part when said vibrating part is in said non-load applied condition.

4. The ultrasonic cosmetic treatment device of claim 1, wherein said oscillation circuit comprises a self exciting oscillation circuit, said ultrasonic cosmetic treatment device further comprising an oscillation frequency rectification circuit that adjusts an oscillation frequency of said oscillation circuit in relation to said first impedance value of said vibrating part when said vibrating part is in said non-load applied condition.

5. An ultrasonic treatment device, comprising:
an ultrasonic oscillator;
a contact member; and
an oscillation circuit that drives said ultrasonic oscillator to vibrate at a predetermined frequency, said oscillation circuit driving said ultrasonic oscillator at a first predetermined frequency when said contact member is in proximate contact with a predetermined surface, said oscillation circuit driving said ultrasonic oscillator at a second predetermined frequency when said contact member is not in said proximate contact with said predetermined surface.

6. The ultrasonic treatment device of claim 5, wherein said first predetermined frequency corresponds to a frequency having a first impedance value.

7. The ultrasonic treatment device of claim 5, wherein said second predetermined frequency corresponds to a frequency having a second impedance value.

8. The ultrasonic treatment device of claim 6, wherein said second predetermined frequency corresponds to a frequency having a second impedance value, said first impedance value being larger than said second impedance value.

9. The ultrasonic treatment device of claim 5, wherein said predetermined surface comprises an outer covering of a body.

10. The ultrasonic treatment device of claim 5, wherein said oscillation circuit comprises an exciter type oscillation circuit.

11. The ultrasonic treatment device of claim 10, wherein said oscillation circuit further comprises an output voltage converting device.

12. The ultrasonic treatment device of claim 5, further comprising an oscillation frequency rectifier device that is interposed between said oscillation circuit and said ultrasonic oscillator.
